(19) United States
(12) Patent Application Publication
(10) Pub. No.: US 2019/0271271 A1
(43) Pub. Date: Sep. 5, 2019

(54) EVAPORATED-FUEL TREATING APPARATUS AND FUEL INJECTION CONTROL APPARATUS FOR ENGINE PROVIDED WITH THE SAME

(71) Applicant: AISAN KOGYO KABUSHIKI KAISHA, Obu-shi (JP)

(72) Inventor: Makoto NAKAGAWA, Nagoya-shi (JP)

(73) Assignee: AISAN KOGYO KABUSHIKI KAISHA, Obu-shi (JP)

(21) Appl. No.: 16/262,200

(22) Filed: Jan. 30, 2019

(30) Foreign Application Priority Data
Mar. 5, 2018 (JP) 2018-038702

(51) Int. Cl. F02D 41/00; F02M 25/08

(52) U.S. Cl. CPC F02D 41/004; F02M 25/0836

(57) ABSTRACT

An evaporated-fuel treating apparatus is configured to collect vapor generated in a fuel tank into a canister, and purge the temporarily collected vapor to an intake passage through a purge passage provided with a purge valve. An ECU controls the purge valve according to an engine operating state to control a purge flow rate of the vapor. The ECU calculates an intake change amount between an intake amount detected when the purge valve is closed not to perform purge and an intake amount detected when the purge valve is opened to perform purge, and calculates an estimated purge flow rate based on an opening degree of the purge valve in an open state and intake pressure detected at that time. The ECU calculates a vapor density difference based on the intake change amount and the estimated purge flow rate and calculates a vapor concentration based on the density difference.

### CROSS-REFERENCE TO RELATED APPLICATIONS

This application is based upon and claims the benefit of priority from the prior Japanese Patent Application No. 2018-038702 filed on Mar. 5, 2018, the entire contents of which are incorporated herein by reference.

### BACKGROUND

### Technical Field

The present disclosure relates to an evaporated-fuel treating apparatus provided in an engine and configured to treat evaporated fuel generated in a fuel tank, and a fuel injection control apparatus for engine provided with the evaporated-fuel treating apparatus.

### Related Art

As the above type of technique, conventionally, there is known an evaporated-fuel treating apparatus disclosed in for example Japanese unexamined patent application publication No. 2003-278590 (“JP 2003-278590A”). This apparatus includes a purge means to purge evaporated fuel (i.e., vapor) generated in an engine (mainly in a fuel tank) to an intake passage, an evaporated-fuel concentration sensor (i.e., a vapor concentration sensor) to detect the concentration of evaporated fuel (i.e., the concentration of vapor) in gas which flows through the intake passage, an exhaust-side sensor to detect an exhaust air-fuel ratio in the engine, a fuel injection valve to inject fuel into the engine, a feedback control means (ECU) to execute feedback control to adjust the exhaust air-fuel ratio at a desired air-fuel ratio based on output of the exhaust-side sensor, a vapor concentration estimating means (ECU) to estimate the vapor concentration in the gas flowing through the intake passage based on a fuel injection control amount during execution of the feedback control, and an associating means (ECU) to associate an estimated value of the vapor concentration with the output of a vapor concentration sensor. Herein, the purge means includes a canister for temporarily adsorbing vapor, a purge passage for allowing the vapor adsorbed to the canister to be purged to the intake passage, and a vapor VSV for adjusting a flow rate of the vapor allowed to flow in the purge passage. According to the foregoing configuration, during execution of the feedback control, the total amount of fuel to be supplied to the engine is adjusted to an amount for achieving a desired air-fuel ratio. Under such a circumstance, the vapor concentration in the gas flowing through the intake passage can be estimated based on the fuel injection amount. By associating the estimated vapor concentration with the output of the vapor concentration sensor, accordingly, their relationship can be specified at a non-atmospheric point (i.e., a point at which the vapor concentration is not zero).

### SUMMARY

### Technical Problem

However, the apparatus disclosed in JP 2003-278590A uses the vapor concentration sensor to estimate the vapor concentration of the gas flowing through the intake passage. Using of this sensor would lead to complicated electric structure and increased cost by just that much. Further, an optimal vapor concentration sensor to each intake passage needs to be determined. This selection requires efforts.

The present disclosure has been made to address the above problems and has a purpose to provide an evaporated-fuel treating apparatus capable of accurately obtaining the concentration of evaporated fuel to be purged to an intake passage without providing a dedicated concentration sensor, and a fuel injection control apparatus for engine provided with the evaporated-fuel treating apparatus.

### Means of Solving the Problem

To achieve the above-mentioned purpose, one aspect of the present disclosure provides an evaporated-fuel treating apparatus to be provided in an engine provided with a throttle valve in an intake passage, the evaporated-fuel treating apparatus including: a canister configured to collect evaporated fuel generated in a fuel tank; a purge passage; and a purge valve provided in the purge passage, the evaporated-fuel treating apparatus being configured to purge and treat evaporated fuel temporarily collected in the canister to the intake passage through the purge passage. The evaporated-fuel treating apparatus further includes: an operating-state detecting unit including an intake amount detecting unit configured to detect an intake amount of intake air flowing through the intake passage upstream of the throttle valve, the operating-state detecting unit being configured to detect an operating state of the engine; and a purge control unit configured to control the purge valve according to the detected operating state of the engine in order to control a purge flow rate of the evaporated fuel to be purged from the purge passage to the intake passage. The purge control unit is configured to: calculate an intake change amount between the intake amount detected when the purge valve is closed, not allowing the evaporated fuel to be purged to the intake passage, and the intake amount detected when the purge valve is opened, allowing the evaporated fuel to be purged to the intake passage; calculate an estimated purge flow rate based on an opening degree of the purge valve in an open state and the operating state of the engine detected at that time; calculate a density difference of the evaporated fuel based on the calculated intake change amount and the calculated estimated purge flow rate; and calculate a concentration of the evaporated fuel based on the calculated density difference.

The configuration in claim 1 can accurately obtain the concentration of evaporated fuel to be purged to an intake passage without providing a dedicated concentration sensor for obtaining the concentration of the evaporated fuel.

### BRIEF DESCRIPTION OF THE DRAWING

FIG. 1 is a schematic diagram showing an engine system including an evaporated-fuel treating apparatus in a first embodiment;

FIG. 2 is a flowchart showing processing contents for calculation of vapor concentration in the first embodiment;

FIG. 3 is an estimated purge flow rate map which will be referred to in order to obtain an estimated purge flow rate according to intake pressure and purge opening degree in the embodiment;

FIG. 4 is a time chart showing behaviors of various parameters when purge is executed and when purge is not executed during engine operation in the embodiment;

FIG. 5 is a flowchart showing processing contents for fuel injection control in the first embodiment;

FIG. 6 is a flowchart showing processing contents for purge control in the first embodiment;

FIG. 7 is a flowchart showing subsequent processing contents for the purge control in the first embodiment;

FIG. 8 is a basic purge opening degree map which will be referred to in order to obtain a basic purge opening degree according to intake pressure and upper limit purge flow rate in the embodiment;

FIG. 9 is a correction value map which will be referred to in order to obtain a correction value according to the intake pressure and a purge flow rate difference in the first embodiment;

FIG. 10 is a flowchart showing processing contents for calculation of vapor concentration in a second embodiment; and

FIG. 11 is a flowchart showing processing contents to correct vapor density in a third embodiment.

### DETAILED DESCRIPTION OF THE EXEMPLARY EMBODIMENTS

### First Embodiment

A detailed description of a first embodiment of an evaporated-fuel treating apparatus and a fuel injection control apparatus for engine provided with the evaporated-fuel treating apparatus, which are embodied as a gasoline engine system, will now be given referring to the accompanying drawings.

### (Outline of Engine System)

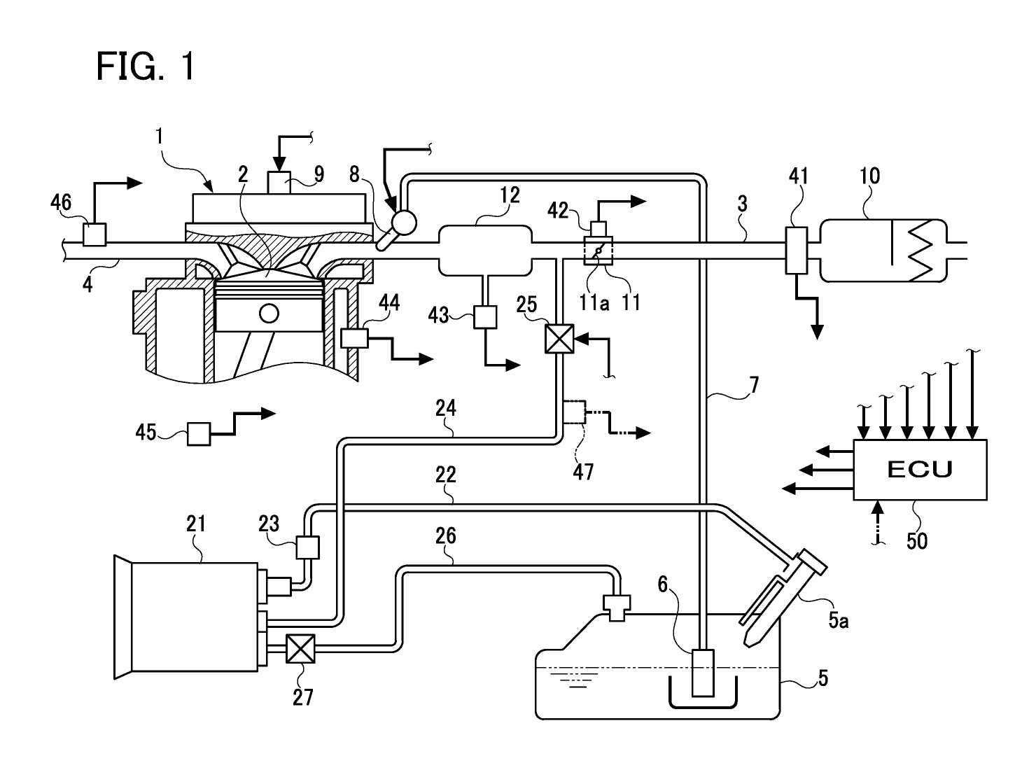

FIG. 1 is a schematic diagram of an engine system including an evaporated-fuel treating apparatus. An engine 1 is provided with an intake passage 3 configured to allow suction of air and others into a combustion chamber 2, and an exhaust passage 4 configured to discharge exhaust air out of the combustion chamber 2. The combustion chamber 2 is supplied with fuel stored in a fuel tank 5. Specifically, the fuel in the fuel tank 5 is ejected into a fuel passage 7 by a fuel pump 6 built in the fuel tank 5 and further fed under pressure to an injector 8 placed in an intake port of the engine 1. The fuel fed under pressure is injected from the injector 8 into the combustion chamber 2, together with the air flowing through the intake passage 3, to form a combustible air-fuel mixture to be combusted. The engine 1 is provided with an ignition device 9 for igniting the combustible air-fuel mixture.

In the intake passage 3, from its entrance toward the engine 1, there are provided an air cleaner 10, a throttle device 11, and a surge tank 12. The throttle device 11 includes a throttle valve 11a configured to open and close in order to regulate a flow rate of intake air flowing through the intake passage 3. The opening/closing of the throttle valve 11a is performed in conjunction with operation of an accelerator pedal (not shown) by a driver. The surge tank 12 is operative to smooth the pulsation of intake air in the intake passage 3.

### (Structure of Evaporated-Fuel Treating Apparatus)

The evaporated-fuel treating apparatus in the present embodiment is configured to collect and treat evaporated fuel (i.e., vapor) generated in the fuel tank 5 without allowing the evaporated fuel (i.e., vapor) to release to the atmosphere. This apparatus is provided with a canister 21 to collect the vapor generated in the fuel tank 5. The canister 21 contains adsorbent material made of activated carbon to adsorb the vapor.

The canister 21 is connected to one end of an atmosphere passage 22 configured to introduce atmospheric air into the canister 21. The other end of the atmosphere passage 22 is communicated with an opening of a fuel filler tube 5a provided in the fuel tank 5. In the atmosphere passage 22, a filter 23 is placed. An end of a purge passage 24 extending from the canister 21 is connected to a portion of the intake passage 3, the portion being located between the throttle device 11 and the surge tank 12. At some place in the purge passage 24, a purge vacuum switching valve (“purge VSV”) 25 which is an electric-operated valve is provided. The purge VSV 25 is configured to change an opening degree in order to regulate a flow rate of vapor flowing through the purge passage 24. The purge VSV 25 corresponds to one example of a purge valve in the present disclosure. An end of a vapor passage 26 extending from the canister 21 is communicated with the fuel tank 5.

This evaporated-fuel treating apparatus is configured such that the canister 21 temporarily collects the vapor generated in the fuel tank 5 through the vapor 26. Further, when the throttle device 11 (the throttle valve 11a) is opened during operation of the engine 1, allowing intake air to flow through the intake passage 3, thereby causing negative pressure to be generated downstream of the throttle device 11. At this time when the negative pressure occurs, the purge VSV 25 is opened, causing the vapor collected in the canister 21 to be purged from the canister 21 to the intake passage 3 through the purge passage 24.

In the present embodiment, in the vapor passage 26, a shutoff valve 27 is provided to control a flow of gas between the fuel tank 5 and the canister 21. This shutoff valve 27 is configured to open when the inner pressure of the fuel tank 5 is a positive pressure equal to or higher than a predetermined value and to close by the negative pressure generated when the vapor collected in the canister 21 is purged to the intake passage 3.

### (Electric Structure of Engine System)

In the present embodiment, various sensors and others 41 to 46 are provided to detect an operating state of the engine 1. An air flow meter 41 placed near the air cleaner 10 is configured to detect the amount of air to be sucked in the intake passage 3, as an intake amount Ga, and output an electric signal representing a detected value thereof. The air flow meter 41 corresponds to one example of an intake amount detecting unit in the present disclosure. A throttle sensor 42 provided in the throttle device 11 is configured to detect an opening degree of the throttle valve 11a, as a throttle opening degree TA, and output an electric signal representing a detected value thereof. An intake pressure sensor 43 provided in the surge tank 12 is configured to detect the internal pressure of the surge tank 12, as intake pressure PM, and output an electric signal representing a detected value thereof. A water temperature sensor 44 provided in the engine 1 is configured to detect the temperature of cooling water flowing through the inside of the engine 1, as a cooling water temperature THW, and output an electric signal representing a detected value thereof. A rotational speed sensor 45 provided in the engine 1 is configured to detect the rotational angle of a crank shaft (not shown) of the engine 1, as an engine rotational speed NE, and output an electric signal representing a detected value thereof. An oxygen sensor 46 provided in the exhaust passage 4 is configured to detect the oxygen concentration Ox of the exhaust gas and output an electric signal representing a detected value thereof. The various sensors and others 41 to 46 correspond to one example of an operating-state detecting unit in the present disclosure.

In the present embodiment, an electronic control unit (ECU) 50 for performing various controls receives various signals Ga, TA, PM, THW, NE, and Ox output from the various sensors and others 41 to 46. The ECU 50 is configured to control the injector 8, the ignition device 9, and the purge VSV 25 based on those input signals to execute fuel injection control, ignition timing control, purge control, vapor concentration calculation processing, and others.

Herein, the fuel injection control is to control the injector 8 according to the operating state of the engine 1 to control the fuel injection amount and the fuel injection timing. The ignition timing control is to control the ignition device 9 according to the operating state of the engine 1 to control the ignition timing of a combustible air-fuel mixture. The purge control is to control the purge VSV 25 according to the operating state of the engine 1 to control the purge flow rate PQ of vapor allowed to flow from the canister 21 to the intake passage 3. The vapor concentration calculation processing is to obtain the purge concentration of vapor by use of the air flow meter 41, the intake pressure sensor 43, and others, which are to be used to detect the operating state of the engine 1. The obtained purge concentration will be reflected in the fuel injection control and the purge control.

In the present embodiment, the ECU 50 corresponds to one example of a purge control unit and a fuel injection control unit in the present disclosure. The ECU 50 is provided with a known structure including a central processing unit (CPU), a read-only memory (ROM), a random-access memory (RAM), a backup RAM, and others. The ROM stores in advance predetermined control programs related to the various controls mentioned above. The ECU (CPU) 50 is configured to execute the foregoing various controls by those control programs.

### (Calculation Processing of Vapor Concentration)

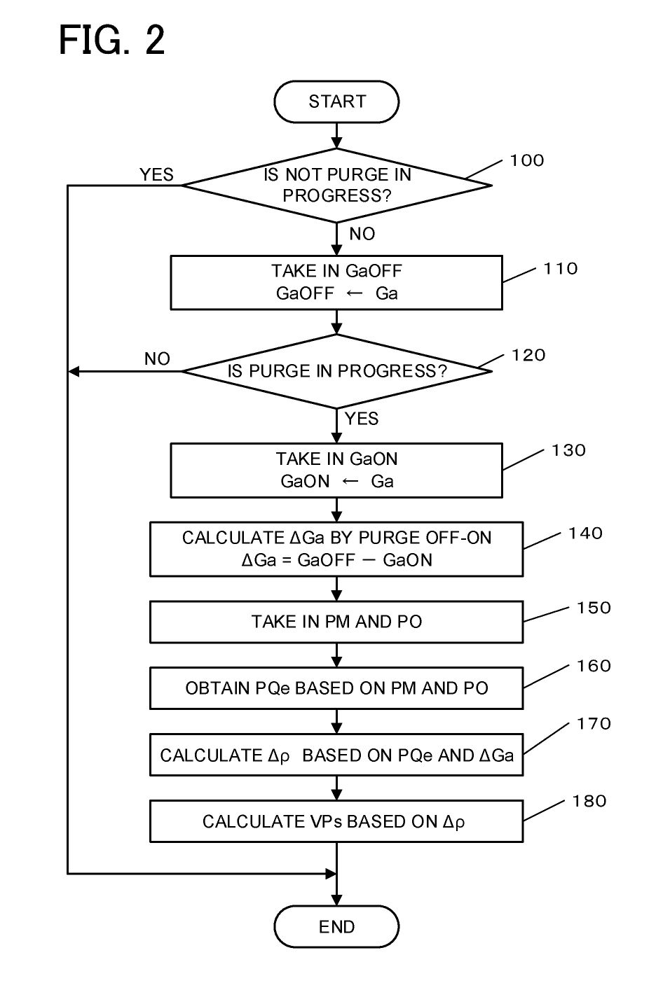

The following description is made on the vapor concentration calculation processing, which is one of various controls to be executed by the ECU 50. FIG. 2 is a flowchart showing processing contents of the vapor concentration calculation processing. The ECU 50 is configured to periodically perform this routine at predetermined time intervals.

When the processing shifts to this routine, the ECU 50 determines, in step 100, whether or not purge is not in progress (i.e., purge is off), that is, whether or not vapor purge is not being executed by the evaporated-fuel treating apparatus. If the determination in step 100 results in NO, indicating purge off, the ECU 50 shifts the processing to step 110. If the determination in step 100 results in YES, indicating purge on, the ECU 50 temporarily stops the processing.

In step 110, the ECU 50 takes a purge-off intake amount GaOFF corresponding to an amount of intake air detected when purge is off. Specifically, the ECU 50 takes in an intake amount Ga detected by the air flow meter 41 as the purge-off intake amount GaOFF.

In step 120, the ECU 50 determines whether or not purge is in progress (i.e., purge is on), that is, whether or not vapor purge is being executed by the evaporated-fuel treating apparatus. If YES in step 120, the ECU 50 advances the processing to step 130. When NO in step 120, the ECU 50 temporarily stops the processing.

In step 130, the ECU 50 takes in a purge-on intake amount GaON corresponding to an amount of intake air detected when purge is on. Specifically, the ECU 50 takes in an intake amount Ga detected by the air flow meter 41 as the purge-on intake amount GaON.

In step 140, successively, the ECU 50 calculates an intake change amount ΔGa corresponding to an amount of change in intake air amount from during purge off to during purge on. To be concrete, the ECU 50 subtracts the purge-on intake amount GaON from the purge-off intake amount GaOFF to calculate the intake change amount ΔGa caused by purge off-on.

In step 150, the ECU 50 takes in an intake pressure PM detected by the intake pressure sensor 43 and a purge opening degree PO of the purge VSV 25 determined when this purge VSV 25 is in an open state.

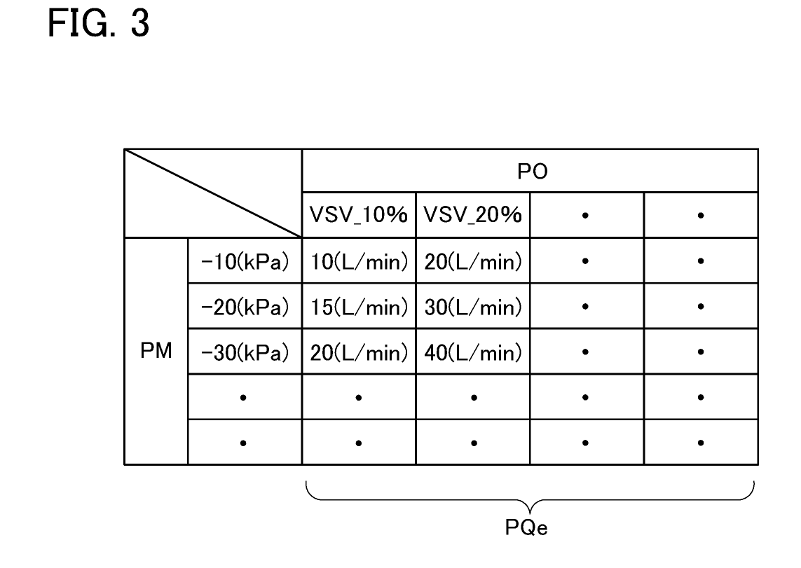

In step 160, the ECU 50 obtains an estimated purge flow rate PQe based on the intake pressure PM and the purge opening degree PO which are taken as above. In the present embodiment, the ECU 50 is configured to refer to an estimated purge flow rate map set in advance as shown in FIG. 3 and thereby obtain the estimated purge flow rate PQe according to the intake pressure PM and the purge opening degree PO. According to this map, for example, when the intake pressure PM is −10 (kPa) and the purge opening degree PO is VSV_20%, the estimated purge flow rate PQe is obtained as 20 (L/min).

In step 170, the ECU 50 then calculates a vapor density difference Δρ based on the estimated purge flow rate PQe and the intake change amount ΔGa. The ECU 50 can calculate the vapor density difference Δρ based on the following equation (1):

Δρ=ρ(PQe/A)²□(A²/(ΔGa−PQe)²) (Eq. 1)

where “ρ” indicates the vapor density and “A” indicates the cross-sectional area of the purge passage 24.

In step 180, the ECU 50 calculates a vapor concentration VPs based on the vapor density difference Δρ and temporarily stops the processing. The ECU 50 can calculate the vapor concentration VPs based on the following equation (2):

VPs=Δρ/ρ (Eq. 2)

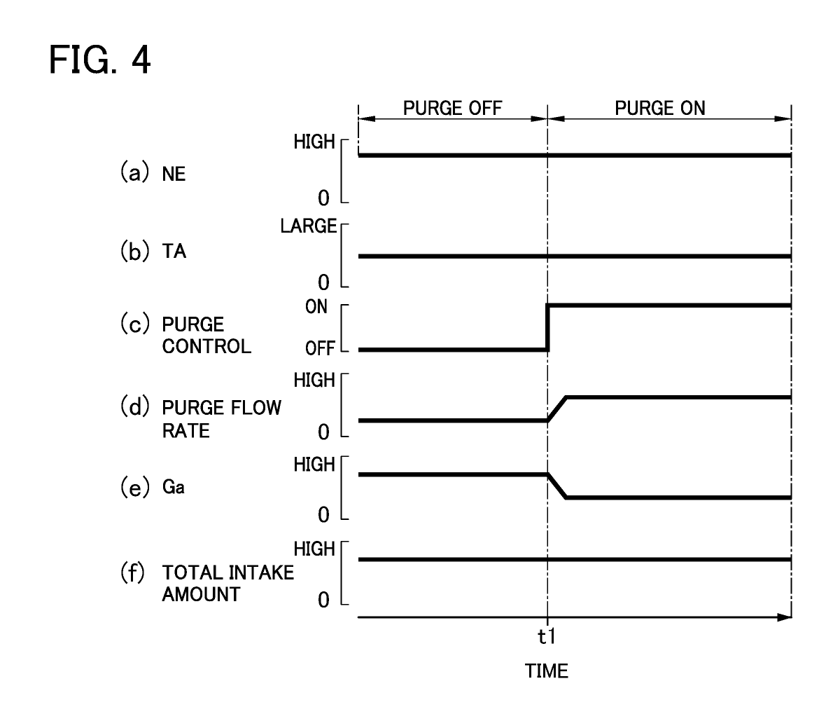

The following explanation is given to the concept of how to calculate the vapor concentration VPs. FIG. 4 is a time chart showing behaviors of various parameters detected when purge is executed (i.e., purge is on) during operation of the engine 1 and when purge is not executed (i.e., during purge off). FIG. 4 shows behaviors of each of (a) engine rotational speed NE, (b) throttle opening degree TA, (c) purge control, (d) purge flow rate, (e) intake amount Ga, and (f) total intake amount of the engine 1. As shown in FIG. 4, while (a) engine rotational speed NE and (b) throttle opening degree TA are constant during operation of the engine 1, when (c) purge control is turned ON at time t1, the purge VSV 25 is opened, allowing vapor to flow through the intake passage 3, so that (d) purge flow rate increases. Concurrently, (e) intake amount Ga decreases. The increased amount of (d) purge flow rate and the decreased amount of (e) intake amount Ga at that time are equal, so that the total intake amount of intake air to be sucked in the engine 1 remains constant before and after purge is turned from off to on.

When the relationship between the increase in purge flow rate PQ and the decrease in intake amount Ga is established as above, a system pressure loss ΔP in the purge passage 24 can be expressed by the following equation (3):

ΔP=ξ□ρ□v²/2 (Eq. 3)

where “ξ” denotes a predetermined loss coefficient and “v” indicates a flow velocity of vapor.

Further, the purge flow rate PQ can be expressed by the following equation (4):

PQ=A□v=A□√(2□ΔP/ξ□ρ) (Eq. 4).

Furthermore, the relationship between a change ΔVPs in the vapor concentration VPs and the estimated purge flow rate PQe can be expressed by the following equation (5):

ΔVPs=ΔGa−PQe=A□√(2□ΔP/ξ□Δρ) (Eq. 5).

Thus, the equation (1) can be derived from the relationship of the equations (3) to (5). The concept in the present embodiment is that when the vapor is caused to flow from the purge passage 24 to the intake passage 3, the intake amount Ga detected by the air flow meter 41 is decreased by an amount equal to the purge flow rate PQ caused to flow. Accordingly, a difference in intake amount Ga (i.e., an intake change amount ΔGa) of intake air that passes through the air flow meter 41 before and after vapor is allowed to flow corresponds to the purge flow rate PQ (i.e., the estimated purge flow rate PQe) of the vapor allowed to flow.

As a conventional purge control, on the other hand, it is conceivable to determine a purge opening degree by reference to a control map (a function data) created in advance to determine the relationship between the intake pressure PM of the intake passage 3, the purge opening degree of the purge VSV 25, and the purge flow rate PQ in the purge passage 24, and control the purge VSV 25 based on the determined purge opening degree in order to control the purge flow rate PQ. This control map shows the relationship established under a special condition. Thus, for instance, if the vapor concentration (i.e., density) varies during execution of purge, the relationship will be broken. It is therefore impossible to accurately control the purge flow rate PQ just by reference to the control map.

In the present embodiment, therefore, the vapor concentration VPs (i.e., density) is calculated from a difference between the intake change amount ΔGa (i.e., the purge flow rate PQ) obtained by the air flow meter 41 and the purge flow rate PQ (i.e., the estimated purge flow rate PQe) obtained from the control map. The air flow meter 41 is a flow meter and thus the detected flow rate does not deviate, or change, even when the vapor concentration VPs (density) varies. A difference between the intake change amount ΔGa and the purge flow rate PQe is regarded as a difference in vapor concentration VPs (density), that is, the vapor density difference Δρ. Thus, the evaporated-fuel treating apparatus in the present embodiment is configured to obtain the vapor density difference Δρ and calculate the vapor concentration VPs from the obtained vapor density difference Δρ.

In the present embodiment, the vapor concentration VPs is calculated from the purge flow rate PQ derived from the intake change amount ΔGa between when purge is not in progress (i.e., “during purge off”) and when purge is in progress (i.e., “during purge on”), that is, between before and after purging. This calculation is performed when a non-purging state is changed to a purging state or reversely when a purging state is changed to a non-purging state. As such a change in state, various occasions may be supposed; for example, (i) the time when vapor starts to be purged after start of the engine 1, (ii) the time when purge is stopped to stop the engine 1, (iii) the time when purge is stopped or started by the fuel injection control (e.g., fuel cut), and others.

According to the foregoing control, the ECU 50 calculates the intake change amount ΔGa between the intake amount Ga (the purge-off intake amount GaOFF) detected when the purge VSV 25 is closed and thus vapor is not purged to the intake passage 3 and the intake amount Ga (the purge-on intake amount GaON) detected when the purge VSV 25 is opened and thus vapor is purged to the intake passage 3. The ECU 50 further calculates the estimated purge flow rate PQe based on the opening degree of the purge VSV 25 in an open state (i.e., the purge opening degree PO) and the operating state of the engine 1 detected at that time (i.e., the intake pressure PM). The ECU 50 then calculates the difference in vapor density (the vapor density difference Δρ) based on the above calculated intake change amount ΔGa and estimated purge flow rate PQe, and calculates the vapor concentration (the vapor concentration VPs) based on the calculated vapor density difference Δρ.

### (Fuel Injection Control)

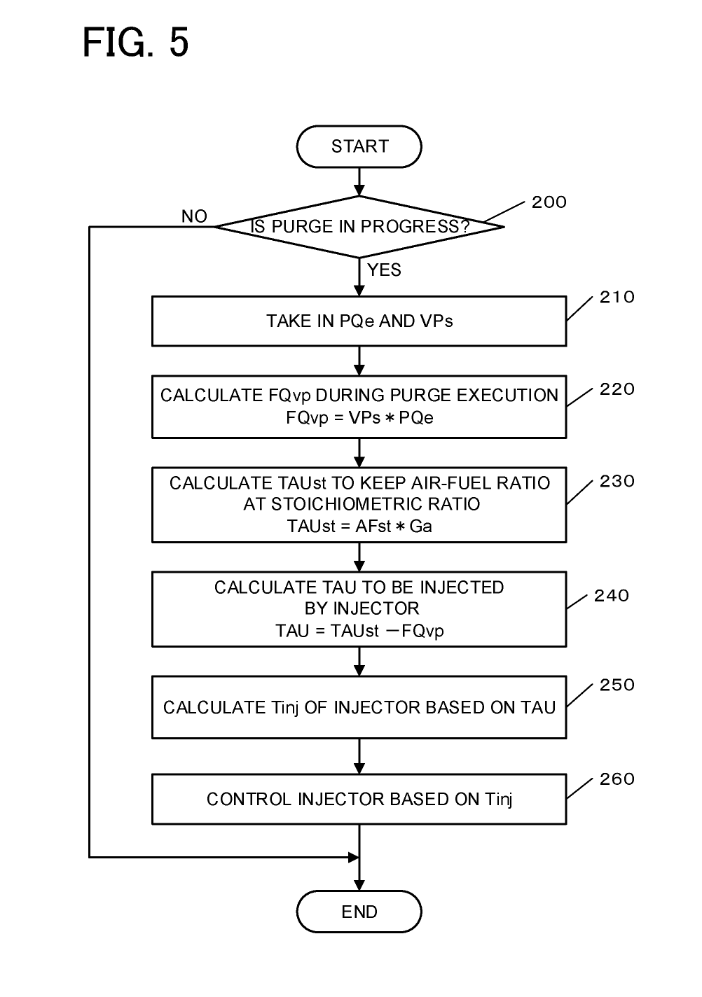

The following description is made on the fuel injection control, which is one of various controls to be executed by the ECU 50. FIG. 5 is a flowchart showing processing contents. The ECU 50 is configured to periodically execute this routine at predetermined time intervals.

When the processing shifts to this routine, in step 200, the ECU 50 determines whether or not purge is in progress (i.e., purge is on). If YES in step 200, the ECU 50 advances the processing to step 210. If NO in step 200, the ECU 50 temporarily stops the processing.

In step 210, the ECU 50 takes in the calculated estimated purge flow rate PQe and the calculated vapor concentration VPs.

In step 220, the ECU 50 calculates a vapor fuel amount FQvp during purge execution. The ECU 50 can calculate this vapor fuel amount FQvp based on the following equation (6):

FQvp=VPs□PQe (Eq. 6).

Specifically, the vapor fuel amount FQvp can be obtained by multiplying the vapor concentration VPs by the estimated purge flow rate PQe.

In step 230, the ECU 50 then calculates a target injection amount TAUst to keep the air-fuel ratio of the engine 1 at a stoichiometric ratio (a ratio of fuel to air at the time of theoretically complete combustion). The ECU 50 can calculate this target injection amount TAUst based on the following equation (7):

TAUst=AFst□Ga (Eq. 7).

Specifically, the target injection amount TAUst for keeping the stoichiometric ratio can be obtained by multiplying a predetermined stoichiometric air-fuel ratio AFst by the intake amount Ga.

In step 240, the ECU 50 calculates a final injection amount TAU of fuel to be injected by the injector 8. The ECU 50 can calculate this final injection amount TAU based on the following equation (8):

TAU=TAUst−FQvp (Eq. 8).

Specifically, the final injection amount TAU can be obtained by subtracting the vapor fuel amount FQvp from the target injection amount TAUst for keeping the stoichiometric ratio.

In step 250, the ECU then calculates a valve open time Tinj of the injector 8 based on the final injection amount TAU. For instance, the ECU 50 can obtain the valve open time Tinj according to the final injection amount TAU and the fuel pressure by referring to a predetermined map.

In step 260, the ECU 50 controls the injector 8 based on the obtained valve open time Tinj. Accordingly, the fuel in an amount corrected in expectation of the purge flow rate of vapor can be supplied to the engine 1.

According to the foregoing control, the ECU 50 is configured to calculate a fuel injection amount according to the operating state of the engine 1 (i.e., the target injection amount TAUst), and correct the calculated target injection amount TAUst based on the vapor concentration VPs, and control the injector 8 based on the fuel injection amount (i.e., the final injection amount TAU).

### (Purge Control)

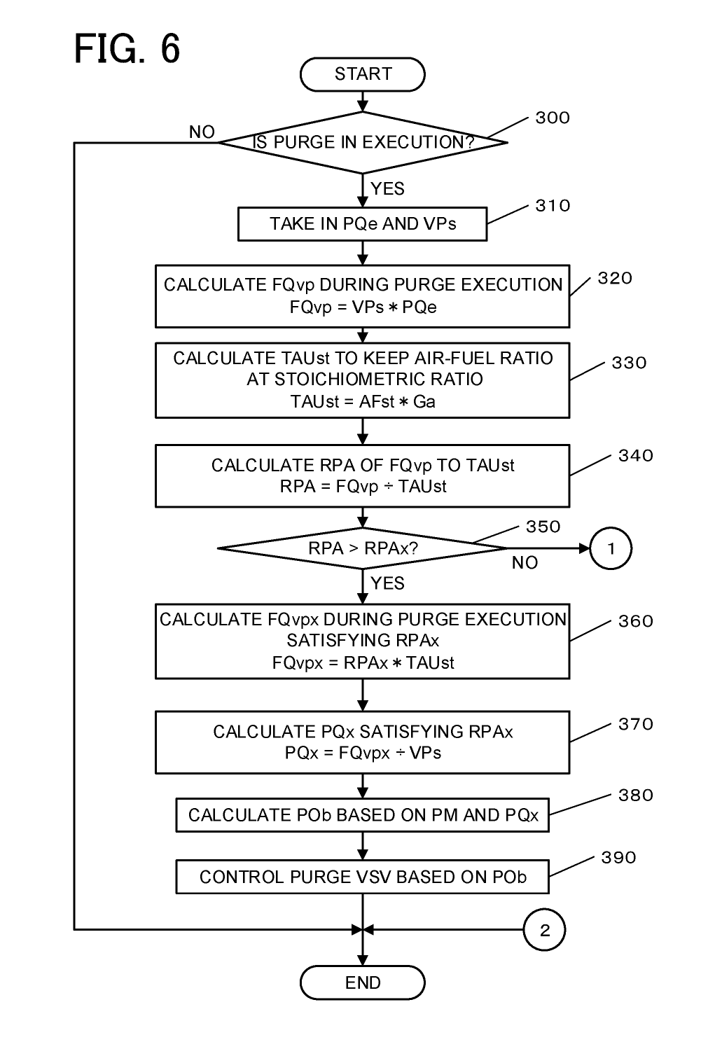

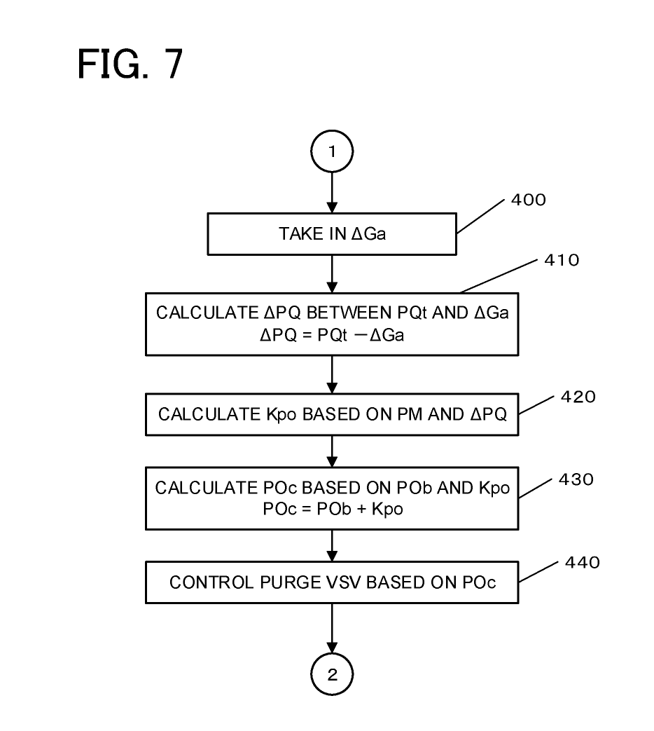

Subsequently, the following explanation is made on the purge control, which is one of various controls to be executed by the ECU 50. FIGS. 6 and 7 are flowcharts showing processing contents thereof. The ECU 50 is configured to periodically perform this routine at predetermined time intervals.

When the processing shifts to this routine, in step 300, the ECU 50 determines whether or not purge is in progress (i.e., purge is on). If YES in step 300, the ECU 50 advances the processing to step 310. If NO in step 300, the ECU 50 temporarily stops the processing.

In step 310, the ECU 50 takes in the calculated estimated purge flow rate PQe and the calculated vapor concentration VPs.

In step 320, the ECU 50 calculates a vapor fuel amount FQvp during purge execution. The ECU 50 can this vapor fuel amount FQvp based on the foregoing equation (6). Specifically, the vapor fuel amount FQvp can be obtained by multiplying the vapor concentration VPs by the estimated purge flow rate PQe.

In step 330, the ECU 50 calculates a target injection amount TAUst to keep the air-fuel ratio of the engine 1 at a stoichiometric ratio. The ECU 50 can calculate this target injection amount TAUst based on the foregoing equation (7).

In step 340, the ECU 50 calculates a purge fuel ratio RPA of the vapor fuel amount FQvp to the target injection amount TAUst for keeping the stoichiometric ratio. The ECU 50 can calculate this purge fuel ratio RPA based on the following equation (9):

RPA=FQvp÷TAUst (Eq. 9).

Specifically, the purge fuel ratio RPA can be obtained by dividing the vapor fuel amount FQvp by the target injection amount TAUst.

In step 350, the ECU 50 determines whether or not the purge fuel ratio RPA is larger than a predetermined upper limit value RPAx. For example, this upper limit value RPAx may be assigned a value at which the injection amount of fuel to be injected by the injector 8 is minimum. If YES in step 350, the ECU 50 advances the processing to step 360. If NO in step 350, the ECU 50 shifts the processing to step 400.

In step 360, the ECU 50 calculates an upper it vapor fuel amount FQvpx during purge execution satisfying the upper limit value RPAx. The ECU 50 can the upper limit vapor fuel amount FQvpx based on the following equation (10):

FQvpx=RPAx□TAUst (Eq. 10).

Specifically, the upper limit vapor fuel amount FQvpx can be obtained by multiplying the upper limit value RPAx by the target injection amount TAUst.

In step 370, the ECU 50 calculates an upper limit purge flow rate PQx satisfying the upper limit value RPAx. The ECU 50 can calculate the upper limit purge flow rate PQx based on the following equation (11):

PQx=FQvpx÷VPs (Eq. 11).

Specifically, the upper limit purge flow rate PQx can be obtained by dividing the upper limit vapor fuel amount FQvpx by the purge concentration VPs.

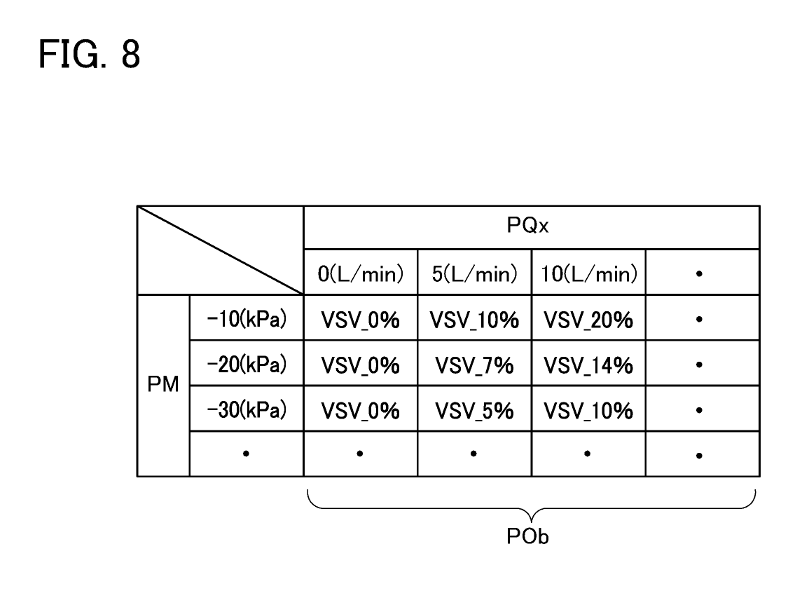

In step 380, the ECU 50 calculates a basic purge opening degree POb based on the intake pressure PM detected by the intake pressure sensor 43 and the obtained upper limit purge flow rate PQx. In the present embodiment, the ECU 50 is configured to obtain the basic purge opening degree POb according to the intake pressure PM and the upper limit purge flow rate PQx by referring to a basic purge opening degree map set in advance as shown in FIG. 8. According to this map, for example, when the intake pressure PM is −10 (kPa) and the upper limit purge flow rate PQx is 5 (L/min), the basic purge opening degree POb is obtained as VSV_10%.

In step 390, furthermore, the ECU 50 controls the purge VSV 25 based on the basic purge opening degree POb and then temporarily stops the processing.

In step 400 following step 350, on the other hand, the ECU 50 takes in a latest intake change amount ΔGa previously obtained.

in step 410, the ECU 50 calculates a difference of the intake change amount ΔGa from a predetermined target purge flow rate PQt, as the purge flow rate difference ΔPQ.

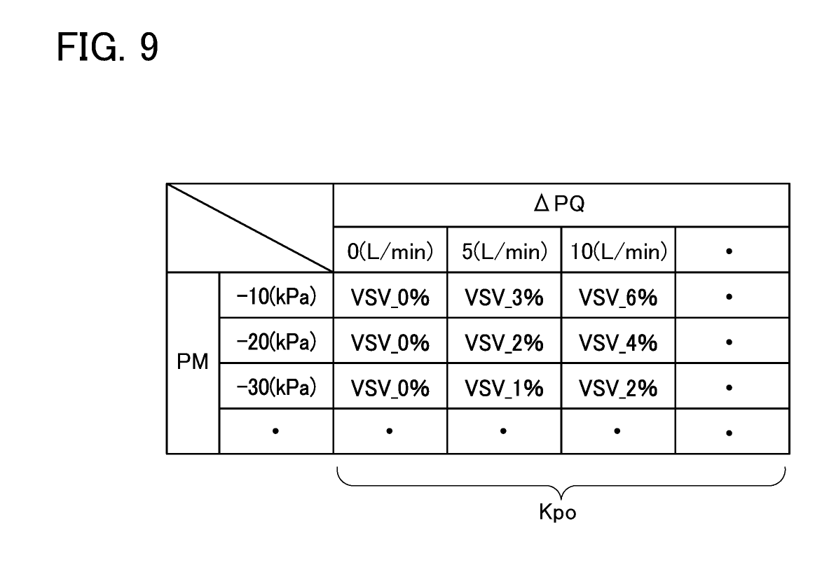

In step 420, the ECU 50 calculates a correction value Kpo of the purge opening degree PO based on the intake pressure PM detected by the intake pressure sensor 43 and the obtained purge flow rate difference ΔPQ. In the present embodiment, the ECU 50 is configured to obtain the correction value Kpo according to the intake pressure PM and the purge flow rate difference ΔPQ by referring to a correction value map set in advance as shown in FIG. 9. According to this map, for example, when the intake pressure PM is −10 (kPa) and the purge flow rate difference ΔPQ is 5 (L/min), the correction value Kpo is obtained as VSV_3%.

In step 430, the ECU 50 adds a currently obtained correction value Kpo to the previously obtained latest basic purge opening degree POb to calculate a post-correction purge opening degree POc.

In step 440, the ECU 50 controls the purge VSV 25 based on the post-correction purge opening degree POc and then temporarily stops the processing.

According to the foregoing control, the ECU 50 is configured to correct the control opening degree (i.e., the purge opening degree PO) of the purge VSV 25 based on the calculated vapor concentration VPs, and control the purge VSV 25 based on this corrected purge opening degree PO (i.e., the post-correction purge opening degree POc).

### (Operations and Effects of Evaporated-Fuel Treating Apparatus and Fuel Injection Control Apparatus)

According to the evaporated-fuel treating apparatus in the present embodiment described as above, when intake air flows in the intake passage 3 during operation of the engine 1, negative pressure is generated in a part of the intake passage 3 downstream of the throttle valve 11a. At that time, the purge VSV 25 is opened, thereby causing the vapor collected in the canister 21 to be drawn into the intake passage 3 through the purge passage 24 and hence purged to the intake passage 3. The purge flow rate PQ determined at this time is regulated according to the purge opening degree PO of the purge VSV 25.

Herein, in the present embodiment, the evaporated-fuel treating apparatus is configured to calculate the intake change amount ΔGa corresponding to the purge flow rate PQ by use of the air flow meter 41 and the intake pressure sensor 43 which are used for normal engine control and constitute an operating-state detecting unit. Specifically, the ECU 50 detects the purge-off intake amount GaOFF determined when the purge VSV 25 is closed, not allowing vapor purge to the intake passage 3, and the purge-on intake amount GaON determined when the purge VSV 25 is opened, allowing vapor purge to the intake passage 3, and thus the ECU 50 calculates a difference between those intake amounts GaOFF and GaON as the intake change amount ΔGa. Further, the ECU 50 calculates the estimated purge flow rate PQe based on the purge opening degree PO of the purge VSV 25 in an open state and the intake pressure PM detected at that time. Then, the ECU 50 calculates the vapor density difference Δρ based on the calculated intake change amount ΔGa and the estimated purge flow rate PQe, and further the ECU 50 calculates the vapor concentration VPs based on the calculated vapor density difference Δρ. Accordingly, the ECU 50 obtains a vapor concentration VPs required to ascertain an accurate purge flow rate PQ of the vapor allowed to flow in the engine 1. Thus, the evaporated-fuel treating apparatus can accurately acquire the vapor concentration VPs of vapor to be purged to the intake passage 3. Consequently, the evaporated-fuel treating apparatus can obtain the vapor concentration VPs with a simple structure and hence can reduce apparatus costs.

According to the evaporated-fuel treating apparatus in the present embodiment, the ECU 50 corrects the control opening degree (i.e., the purge opening degree PO) of the purge VSV 25 based on the vapor concentration VPs calculated as above, and controls the purge VSV 25 based on the corrected control opening degree (i.e., the post-purge opening degree POc). Accordingly, the purge flow rate PQ of vapor to be purged to the intake passage 3 can be appropriately adjusted. This enables accurate control of a total amount of fuel to be supplied to the engine 1 (that is, a fuel injection amount+a purge flow rate PQ of vapor) and thus the air-fuel ratio of the engine 1 can be controlled with accuracy.

According to the fuel injection control apparatus for an engine in the present embodiment, the ECU 50 corrects the calculated fuel injection amount (i.e., the target injection amount TAUst) based on the calculated vapor concentration VPs. Thus, the amount of fuel to be injected from the injector 8 can be appropriately adjusted according to the purge flow rate PQ of vapor to be purged to the intake passage 3. This enables accurate control of the amount of fuel to be injected from the injector 8. In this regard, the air-fuel ratio of the engine 1 can also be controlled accurately.

### Second Embodiment

Next, a second embodiment of an evaporated-fuel treating apparatus and a fuel injection control apparatus for engine provided with the evaporated-fuel treating apparatus, which are embodied as a gasoline engine system, will now be given referring to the accompanying drawings.

In the following description, identical or similar parts to those in the first embodiment are assigned the same reference signs as in the first embodiment. The following explanation is given with a focus on differences from the first embodiment.

The present embodiment differs from the first embodiment in the electric structure of the evaporated-fuel treating apparatus and the contents of calculation processings of vapor concentration.

### (Structure of Evaporated-Fuel Treating Apparatus)

In the present embodiment, as indicated by a two-dot chain line in FIG. 1, a vapor temperature sensor 47 is provided in the purge passage 24. This vapor temperature sensor 47 is configured to detect the vapor temperature Tvp of vapor flowing through the purge passage 24 and output an electric signal representing a detected value thereof to the ECU 50. The vapor temperature sensor 47 corresponds to one example of an evaporated fuel temperature detecting unit in the present disclosure.

### (Calculation Processing of Vapor Concentration)

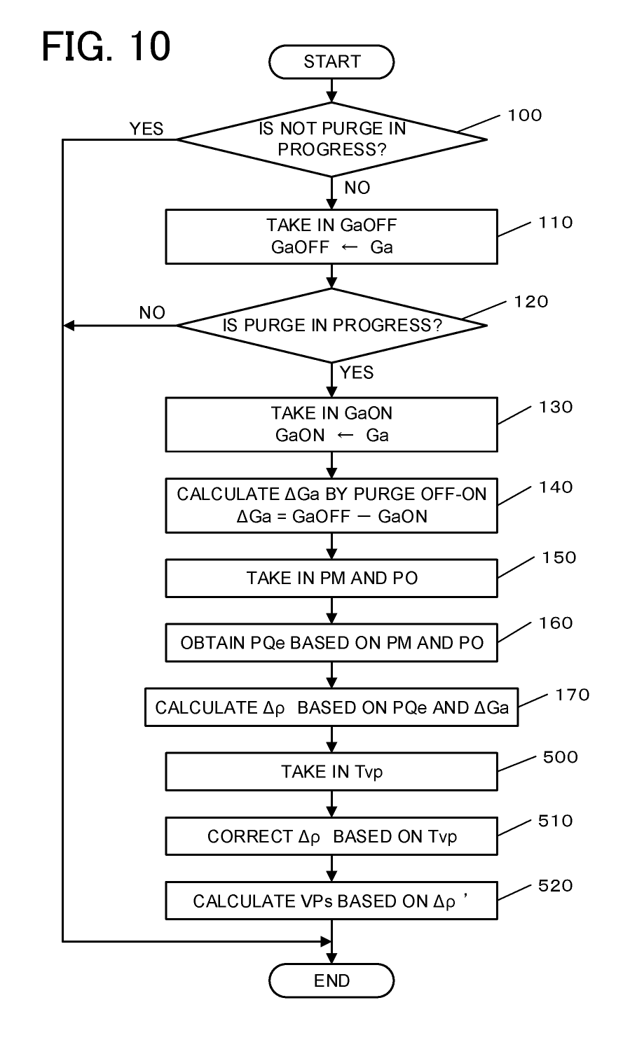

FIG. 10 is a flowchart showing processing contents for calculation of vapor concentration. In FIG. 10, the processings in steps 100 to 170 are the same as those in FIG. 2. The ECU 50 is configured to periodically perform this routine at predetermined intervals.

When the processing shifts to this routine, the ECU 50 performs the processings in the steps 100 to 170 and successively, in step 500, takes in a vapor temperature Tvp from the vapor temperature sensor 47.

In step 510, the ECU 50 corrects the vapor density difference Δρ based on the vapor temperature Tvp. The ECU 50 can obtain a post-correction vapor density difference Δρ′ as a result of correction according to the vapor temperature Tvp for example by referring to a predetermined vapor temperature correction map.

In step 520, the ECU 50 calculates the vapor concentration VPs based on the post-correction vapor density difference Δρ′. To be concrete, the vapor concentration VPs is calculated by substituting Δρ′ for Δρ in the foregoing equations (2) and (5). Then, the ECU 50 temporarily stop the processing.

According to the foregoing control, the ECU 50 is configured to correct the vapor density difference Δρ based on the detected vapor temperature Tvp, and calculate the vapor concentration VPs based on this corrected vapor density difference Δρ (i.e., the post-correction vapor density difference Δρ′).

According to the evaporated-fuel treating apparatus in the present embodiment, therefore, the following operations and effects can be achieved in addition to the operations and effects in the first embodiment. Specifically, the vapor concentration VPs of vapor to be purged to the intake passage 3 may change with the vapor temperature Tvp. In the present embodiment, however, the ECU 50 corrects the vapor density difference Δρ based on the vapor temperature Tvp and calculates the vapor concentration VPs based on the corrected vapor density difference (i.e., the post-correction vapor density difference) Δρ′. Thus, the vapor concentration VPs is appropriately corrected according to the vapor temperature Tvp. This enables more accurate calculation of the vapor concentration VPs of vapor to be purged to the intake passage 3.

### Third Embodiment

Next, a third embodiment of an evaporated-fuel treating apparatus and a fuel injection control apparatus for engine provided with the evaporated-fuel treating apparatus, which are embodied as a gasoline engine system, will now be given referring to the accompanying drawings.

### (Calculation Processing of Vapor Concentration)

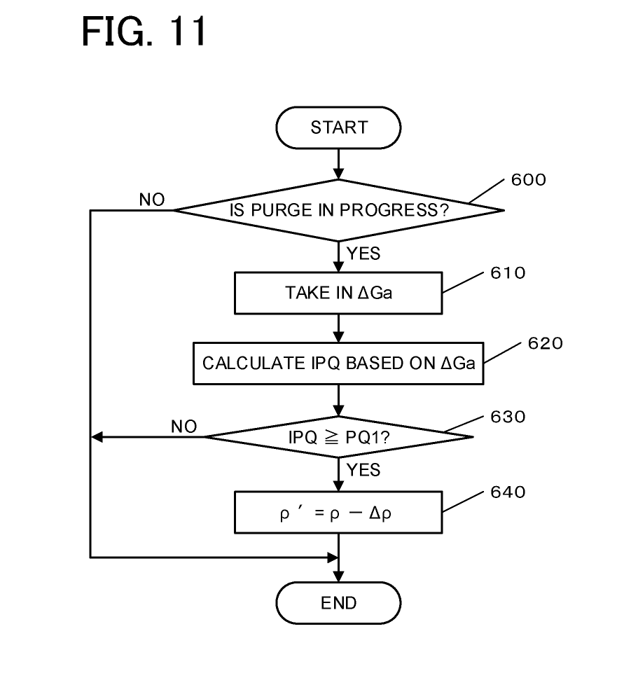

The present embodiment differs from the first and second embodiments in the contents of calculation processings of vapor concentration. In the present embodiment, specifically, when vapor purge continues to be performed for a certain time from the start of purge, the vapor density ρ in the equation (3) to be used for calculation of the system pressure loss ΔP mentioned above is corrected. FIG. 11 is a flowchart showing the processing contents.

When the processing shifts to this routine, in step 600, the ECU 50 determines whether or not purge is in progress (i.e., purge is on). If YES in step 600, the ECU 50 advances the processing to step 610. If NO in step 600, the ECU 50 temporarily stops the processing.

In step 610, the ECU 50 takes in the intake change amount ΔGa calculated separately. Herein, the intake change amount ΔGa represents a purge flow rate PQ obtained at that time.

In step 620, the ECU 50 then calculates an accumulated purge flow rate IPQ based on the intake change amount ΔGa. In other words, the ECU 50 accumulates the intake change amount ΔGa taken in before this time to obtain the accumulated purge flow rate IPQ corresponding to a purge flow rate accumulated from the start of purge.

In step 630, the ECU 50 determines whether or not the calculated accumulated purge flow rate IPQ is equal to or larger than a predetermined PQ1. In other words, the ECU 50 determines whether or not a predetermined amount of vapor has flowed out of the canister 21 from the start of purge. If YES in step 630, the ECU 50 advances the processing to step 640. If NO in step 630, the ECU 50 temporarily stops subsequent processing.

In step 640, the ECU 50 corrects the vapor density ρ. Specifically, the ECU 50 subtracts the vapor density difference Δρ from the vapor density ρ to calculate a post-correction vapor density ρ′. Then, the ECU 50 temporarily stops the processing.

According to the foregoing control, the ECU 50 is configured to calculate the vapor density difference Δρ based on the vapor density ρ and the cross-sectional area A of the purge passage 24 in addition to the intake change amount ΔGa and the estimated purge flow rate PQe. The ECU 50 is further configured to calculate the accumulated purge flow rate IPQ obtained when the purge VSV 25 is in the open state, correct the vapor density ρ when the calculated accumulated purge flow rate IPQ is the predetermined value PQ1 or larger, and calculate the post-correction vapor density ρ′.

According to the evaporated-fuel treating apparatus in the present embodiment, consequently, the following operations and effects can be achieved in addition to the operations and effects in each of the foregoing embodiments. In other words, the vapor density ρ may change with pressure loss in the canister 21 and the purge passage 24. This may be caused by clogging of the adsorption material contained in the canister 21. In the present embodiment, however, when the accumulated purge flow rate IPQ from the start of purge is equal to or larger than the predetermined value PQ1, the ECU 50 corrects the vapor density ρ to be used for calculation of pressure loss in the purge passage 24. Accordingly, since the pressure loss in the purge passage 24 which may change with age deterioration of the canister 21 and others, a more accurate vapor density difference Δρ is calculated by the ECU 50. Thus, an accurate vapor concentration PVs can be obtained irrespective of pressure loss change in the purge passage 24 and others.

The present disclosure is not limited to each of the foregoing embodiments and may be embodied in other specific forms without departing from the essential characteristics thereof.

(1) In each of the foregoing embodiments, in the engine system provided with no supercharger, the evaporated-fuel treating apparatus is configured such that the purge passage 24 is placed to communicate with a part of the intake passage 3, downstream of the throttle valve 11a, such that vapor is purged from the purge passage 24 to the intake passage 3 by negative pressure generated downstream of the throttle valve 11a. As an alternative, in an engine system provided with a supercharger, the evaporated-fuel treating apparatus may be configured such that a purge passage is placed to communicate with a part of an intake passage, upstream of a throttle valve and downstream of an air flow meter, and a pump is provided in the purge passage in addition to a purge VSV to purge vapor from the purge passage to the intake passage by operation of the pump.

(2) In the second embodiment described above, the evaporated fuel temperature detecting unit is constituted of the vapor temperature sensor 47 provided in the purge passage 24. As alternative, the intake temperature sensor provided at the entrance of the intake passage may also be used as the evaporated fuel temperature detecting unit. Specifically, the intake temperature detected by the intake temperature sensor can be used as a temperature related to the vapor temperature to correct the vapor concentration with temperature.

(3) In each of the foregoing embodiments, the estimated purge flow rate PQe is calculated based on the purge opening degree PO and the intake pressure PM detected by the intake pressure sensor 43 at that time. As an alternative, the estimated purge flow rate PQe can be calculated based on the purge opening degree PO, the intake amount Ga detected by the air flow meter 41 at that time, the throttle opening degree TA (corresponding to pressure loss) detected by the throttle sensor 42 at that time.

### INDUSTRIAL APPLICABILITY

The present disclosure is applicable to an engine system provided with an evaporated-fuel treating apparatus.

### REFERENCE SIGNS LIST

1 Engine
3 Intake passage
5 Fuel tank
8 Injector
11 Throttle device
11a Throttle valve
21 Canister
24 Purge passage
25 Purge VSV (Purge valve)
41 Air flow meter (Intake amount detecting unit, Operating state detecting unit)
42 Throttle sensor (Operating state detecting unit)
43 Intake pressure sensor (Operating state detecting unit)
47 vapor temperature sensor (Evaporated fuel temperature detecting unit)
50 ECU (Purge control unit, Fuel injection control unit)
Ga Intake amount
PM Intake pressure
Tvp Vapor temperature
GaOFF Purge-off intake amount
GaON Purge-on intake amount
ΔGa Intake change amount
PO Purge opening degree
POc Post-correction purge opening degree
Pq Purge flow rate
IPO Accumulated purge flow rate
PQe Estimated purge flow rate
VPs Vapor concentration
PQ1 Predetermined value
ρ Vaper density
ρ′ Post-correction vapor density
Δρ Vaper density difference
Δρ′ Post-correction vapor density difference
A Cross-sectional area of purge passage
TAUst Target injection amount for keeping stoichiometric ratio
TAU Final injection amount

What is claimed is:

1. An evaporated-fuel treating apparatus to be provided in an engine provided with a throttle valve in an intake passage, the evaporated-fuel treating apparatus comprising:
a canister configured to collect evaporated fuel generated in a fuel tank;
a purge passage; and
a purge valve provided in the purge passage,
the evaporated-fuel treating apparatus being configured to purge and treat evaporated fuel temporarily collected in the canister to the intake passage through the purge passage,
wherein the evaporated-fuel treating apparatus further comprises:
are operating-state detecting unit including an intake amount detecting unit configured to detect an intake amount of intake air flowing through the intake passage upstream of the throttle valve, the operating-state detecting unit being configured to detect an operating state of the engine; and
a purge control unit configured to control the purge valve according to the detected operating state of the engine in order to control a purge flow rate of the evaporated fuel to be purged from the purge passage to the intake passage, and
the purge control unit is configured to:
calculate an intake change amount between the intake amount detected when the purge valve is closed, not allowing the evaporated fuel to be purged to the intake passage, and the intake amount detected when the purge valve is opened, allowing the evaporated fuel to be purged to the intake passage;
calculate an estimated purge flow rate based on an opening degree of the purge valve in an open state and the operating state of the engine detected at that time;
calculate a density difference of the evaporated fuel based on the calculated intake change amount and the calculated estimated purge flow rate; and
calculate a concentration of the evaporated fuel based on the calculated density difference.

2. The evaporated-fuel treating apparatus according to claim 1, wherein
the evaporated-fuel treating apparatus further comprises an evaporated fuel temperature detecting unit configured to detect a temperature of the evaporated fuel, and
the purge control unit is configured to correct the density difference of the evaporated fuel based on the detected temperature and calculate the concentration of the evaporated fuel based on the corrected density difference.

3. The evaporated-fuel treating apparatus according to claim 1, wherein
the purge control unit is configured to calculate the density difference of the evaporated fuel based on a density of the evaporated fuel and a cross-sectional area of the purge passage in addition to the intake change amount and the estimated purge flow rate, and
the purge control unit is configured to calculate an accumulated purge flow rate obtained when the purge valve is in an open state based on the intake change amount, and correct the density of the evaporated fuel when the calculated accumulated purge flow rate is equal to or larger than a predetermined value.

4. The evaporated-fuel treating apparatus according to claim 2, wherein
the purge control unit is configured to calculate the density difference of the evaporated fuel based on a density of the evaporated fuel and a cross-sectional area of the purge passage in addition to the intake change amount and the estimated purge flow rate, and
the purge control unit is configured to calculate an accumulated purge flow rate obtained when the purge valve is in an open state based on the intake change amount, and correct the density of the evaporated fuel when the calculated accumulated purge flow rate is equal to or larger than a predetermined value.

5. The evaporated-fuel treating apparatus according to claim 1, wherein the purge control unit is configured to correct a control opening degree of the purge valve based on the calculated concentration of the evaporated fuel, and control the purge valve based on the corrected control opening degree.

6. The evaporated-fuel treating apparatus according to claim 2, wherein the purge control unit is configured to correct a control opening degree of the purge valve based on the calculated concentration of the evaporated fuel, and control the purge valve based on the corrected control opening degree.

7. The evaporated-fuel treating apparatus according to claim 3, wherein the purge control unit is configured to correct a control opening degree of the purge valve based on the calculated concentration of the evaporated fuel, and control the purge valve based on the corrected control opening degree.

8. The evaporated-fuel treating apparatus according to claim 4, wherein the purge control unit is configured to correct a control opening degree of the purge valve based on the calculated concentration of the evaporated fuel, and control the purge valve based on the corrected control opening degree.

9. A fuel injection control apparatus for an engine provided with the evaporated-fuel treating apparatus according to claim 1, wherein
the fuel injection control apparatus comprises:
an injector configured to inject fuel into the engine; and
a fuel injection control unit configured to control the injector, and
the fuel injection control unit is configured to:
calculate a fuel injection amount based on the detected operating state of the engine;
correct the calculated fuel injection amount based on the concentration of the evaporated fuel; and
control the injector based on the corrected fuel injection amount.

10. A fuel injection control apparatus for an engine provided with the evaporated-fuel treating apparatus according to claim 2, wherein
the fuel injection control apparatus comprises:
an injector configured to inject fuel into the engine; and
a fuel injection control unit configured to control the injector, and
the fuel injection control unit is configured to:
calculate a fuel injection amount based on the detected operating state of the engine;
correct the calculated fuel injection amount based on e concentration of the evaporated fuel; and
control the injector based on the corrected fuel injection amount.

11. A fuel injection control apparatus for an engine provided with the evaporated-fuel treating apparatus according to claim 3, wherein
the fuel injection control apparatus comprises:
an injector configured to inject fuel into the engine; and
a fuel injection control unit configured to control the injector, and
the fuel injection control unit is configured to:
calculate a fuel injection amount based on the detected operating state of the engine;
correct the calculated fuel injection amount based on the concentration of the evaporated fuel; and
control the injector based on the corrected fuel injection amount.

12. A fuel injection control apparatus for an engine provided with the evaporated-fuel treating apparatus according to claim 5, wherein
the fuel injection control apparatus comprises:
an injector configured to inject fuel into the engine; and
a fuel injection control unit configured to control the injector, and
the fuel injection control unit is configured to:
calculate a fuel injection amount based on the detected operating state of the engine;
correct the calculated fuel injection amount based on the concentration of the evaporated fuel; and
control the injector based on the corrected fuel injection amount.
